(19) United States
(12) Patent Application Publication
(10) Pub. No.: US 2015/0262116 A1
(43) Pub. Date: Sep. 17, 2015

(54) MACHINE VISION TECHNOLOGY FOR SHELF INVENTORY MANAGEMENT

(71) Applicant: International Business Machines Corporation, Armonk, NY (US)

(72) Inventors: Kaan K. Katircioglu, Yorktown Heights, NY (US); Ying Li, Mohegan Lake, NY (US)

(73) Assignee: International Business Machines Corporation, Armonk, NY (US)

(21) Appl. No.: 14/215,006

(22) Filed: Mar. 16, 2014

(51) Int. Cl. G06Q 10/08; G06K 9/18; G06K 9/62; G06K 9/46; A47F 10/00; A47F 5/00

(52) U.S. Cl. CPC G06Q 10/087; A47F 10/00; A47F 5/0043; G06K 9/6215; G06K 9/4604; G06K 9/18

(57) ABSTRACT

A system, method and computer program product for maintaining shelf inventory data on a shelf. The system includes a camera for capturing shelf images of items on the shelf. An inventory database stores a product name, type, barcode, image and inventory data. An image-count correlation database stores historical product inventory images and product shelf inventory counts associated with the products in the historical images which are read from the product inventory database. A computer processor segments the shelf images into product inventory images, matches the inventory images with the historical images, and updates the shelf inventory data in the inventory database based on the product shelf inventory counts associated with the matched historical images in the image-count correlation database.

### BACKGROUND

The present invention relates to inventory management. More particularly, the present invention relates to automated monitoring of shelf inventory.

Machine vision technology is the application of automated image-based analysis for a variety of purposes. Machine vision technology has been applied to retail solutions generally for customer-based applications. For example, cameras and image processing have been utilized to monitor customer traffic patterns and customer counts, to assist in store layout and staff planning, respectively. Other examples include, monitoring customer item returns fraud, self-checkout systems, and cashier scanning accuracy.

For retailers and storage facilities, it is critical to effectively monitor shelf inventory. In retail stores, a frequent out-of-stock condition (OOS) results in reduced profits. Excessive OOS is generally attributable to store processes, including shelf space allocation, restock frequency, and ongoing monitoring of shelf stock. The most common method of shelf inventory management is manual shelf monitoring by store staff. However, manual staff monitoring is labor intensive and subject to staff availability. Another conventional method of inventory management is to utilize point of sales (POS) data, however, POS data does not address issues of involving item locations within a retail or storage space, such as misplaced inventory. Radio-Frequency Identification (RFID) technology to monitor individual items has been suggested as an automated solution to inventory management. However, the application of tracking tags on each individual item results in high implementation costs.

### BRIEF SUMMARY

An aspect of the present invention is a system for maintaining product shelf inventory data on a shelf. The system includes a camera configured to capture a shelf image of a plurality of items on the shelf. The system also includes an image-count correlation database storing historical images of each product type on the shelf, and a product shelf inventory count associated with each of the products which is read from a product inventory database when the images were taken. The system includes a computer processor configured to segment the shelf image into at least a first inventory image. The first inventory image contains only items of a single product type on the shelf. The processor is also configured to match the first inventory image with one of the historical images, and potentially update the product's shelf inventory data based on the product shelf inventory count associated with the matched historical image.

Another aspect of the present invention is a method for maintaining product shelf inventory data on a shelf. The method includes capturing a shelf image of a plurality of items on the shelf. The method also includes segmenting the shelf image into at least a first inventory image. The first inventory image containing only items of a single product type on the shelf. The method includes matching the first inventory image with a historical image from an image-count correlation database. The database storing historical images of each product type on the shelf and a product shelf inventory count associated with each of the products which is read from a product inventory database when the images were taken. The method also includes potentially updating the product's shelf inventory data based on the product shelf inventory count associated with the matched historical image.

Yet another aspect of the present invention is a computer program product for maintaining product shelf inventory data on a shelf. The computer program product includes program code to capture a shelf image of items on the shelf, segment the shelf image into an inventory image that contains only items of a single product type on the shelf, match the inventory image with a historical image from an image-count correlation database, and potentially update the product's shelf inventory data based on a product shelf inventory count associated with the matched historical image.

### BRIEF DESCRIPTION OF THE DRAWINGS

FIG. 1A shows an example of mounting cameras on store shelves, according to one embodiment of the present invention.

FIG. 1B is a simplified top-down view of two cameras which have overlapped field-of-view.

FIG. 2 is a diagram depicting an example process for image segmentation utilizing edge detection data.

FIG. 3A is a diagram depicting an example process for correlating a product inventory image with its shelf inventory data, according to one embodiment of the present invention.

FIG. 3B is a diagram depicting another example process for correlating a product inventory image with its shelf inventory data at a different time instant.

FIG. 4 is a diagram depicting an example process for matching a product inventory image with images in the image-count correlation database, and subsequently deriving and updating the product's shelf inventory data, according to one embodiment of the present invention.

FIG. 5 is a flowchart illustrating a method for maintaining a product's inventory data on a shelf, according to one embodiment of the present invention.

FIG. 6 is a diagram depicting an example process for recognizing each specific product type on the shelf based on image segmentation results.

FIG. 7 is a diagram depicting an example process for identifying and verifying products utilizing identifier tags.

FIG. 8 is a diagram depicting an example process for identifying displaced products utilizing identifier tags.

FIG. 9 is a diagram depicting an example of detecting out-of-stock products based on shelf image processing.

FIG. 10 is a diagram depicting an example process for maintaining and updating shelf inventory data, according to one embodiment of the present invention.

FIG. 11 is a diagram depicting another example process for maintaining and updating shelf inventory data, according to one embodiment of the present invention.

### DETAILED DESCRIPTION

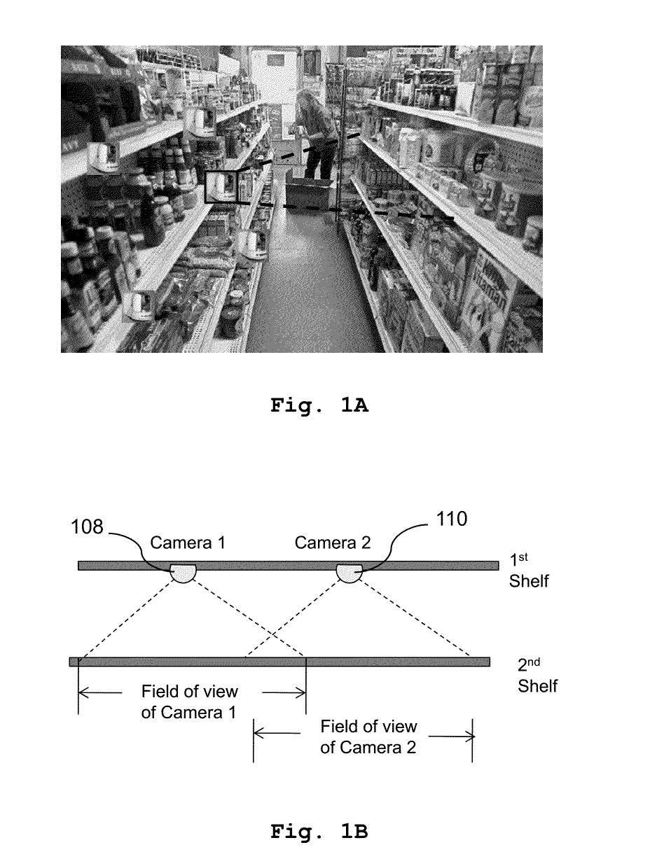

It is initially noted that the configurations described below and depicted in the figures are for the purpose of illustrating suggested embodiments of the present invention. Therefore, the present invention encompasses alternative orientations and configurations of the suggested embodiments. Throughout the description of the invention reference is made to FIGS. 1A-11. When referring to the figures, like structures and elements shown throughout are indicated with like reference numerals.

An aspect of the invention is a system and method for maintaining product inventory data on a shelf utilizing shelf inventory data and machine vision technology. The system builds an image-count correlation database with segmented shelf images associated with the corresponding products' shelf inventory counts.

FIG. 1A shows an example of mounting cameras on store shelves, according to one embodiment of the present invention. The picture depicts a plurality of cameras located on a shelf. The cameras are arranged horizontally across each level of the shelf. Each camera is configured to continuously capture images of items on the shelf across the aisle. FIG. 1A also depicts the boundaries for the field of view of one of the cameras (dotted lines). In some embodiments, the cameras may be pan-tilt-zoom cameras (PTZ). In some embodiments, the cameras may capture video of items on the shelf across the aisle.

FIG. 1B is a simplified top-down view of two cameras mounted on one store shelf while facing a second shelf. The cameras include a first camera 108 and a second camera 110. The first camera 108 includes a first field of view and the second camera 110 includes a second field of view. The first and second fields of view both face the second shelf. The first field of view may partially overlap with the second field of view, such that certain products on the second shelf are visible to both cameras. This embodiment depicts cameras positioned and overlapping in a horizontal alignment, however, other embodiments may also include vertically aligned cameras with or without overlapping fields of view.

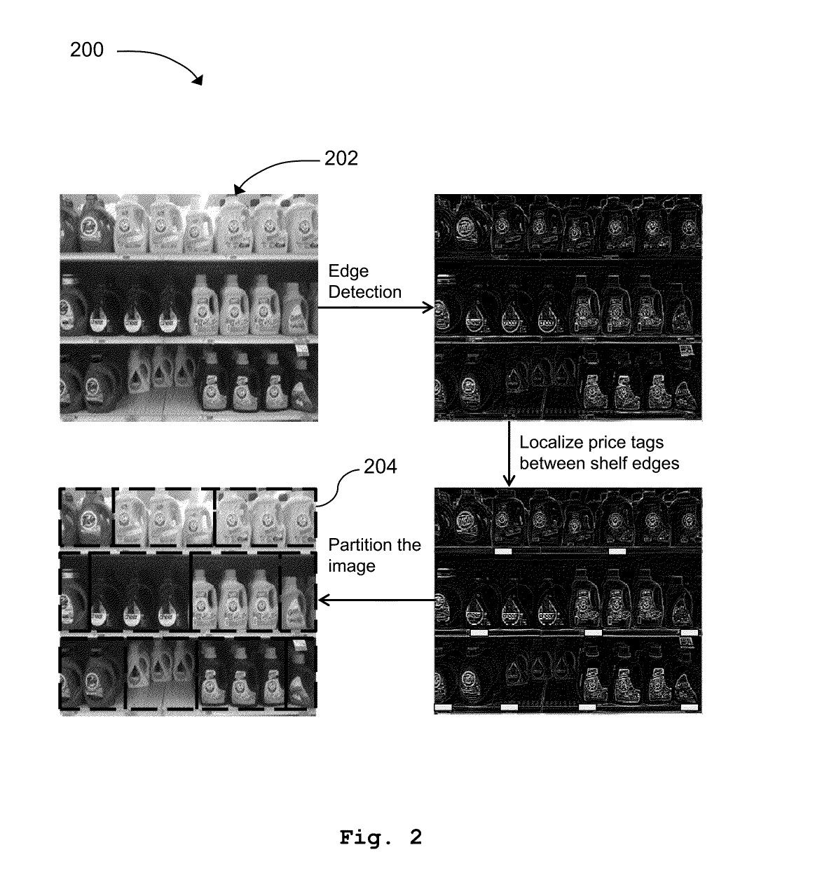

FIG. 2 is a diagram depicting an example process for image segmentation utilizing edge detection data, according to one embodiment of the present invention. As used herein, “segmentation” is the process of partitioning a digital image into patches so that each image patch only contains one specific product. Image segmentation is used to locate objects and boundaries in images. In this embodiment, the shelf image 202 first goes through an edge detection process which produces an edge image. One skilled in the art would recognize the various methods for performing edge detection, such as phase congruency-based edge detection, thresholding and linking, differential edge detection, and edge detection using Sobel or Laplacian operator. In some embodiments, identifier tags associated with the items are located on the shelves and are captured in the shelf image 202. Based on detected edges and localized identifier tags, the shelf image 202 is segmented into a plurality of inventory images 204, each corresponding to a particular product type. In this embodiment, the shelf is in a retail store and the identifier tags are price tags, however, the identifier tags may be tags solely for the purpose of product identification by the system.

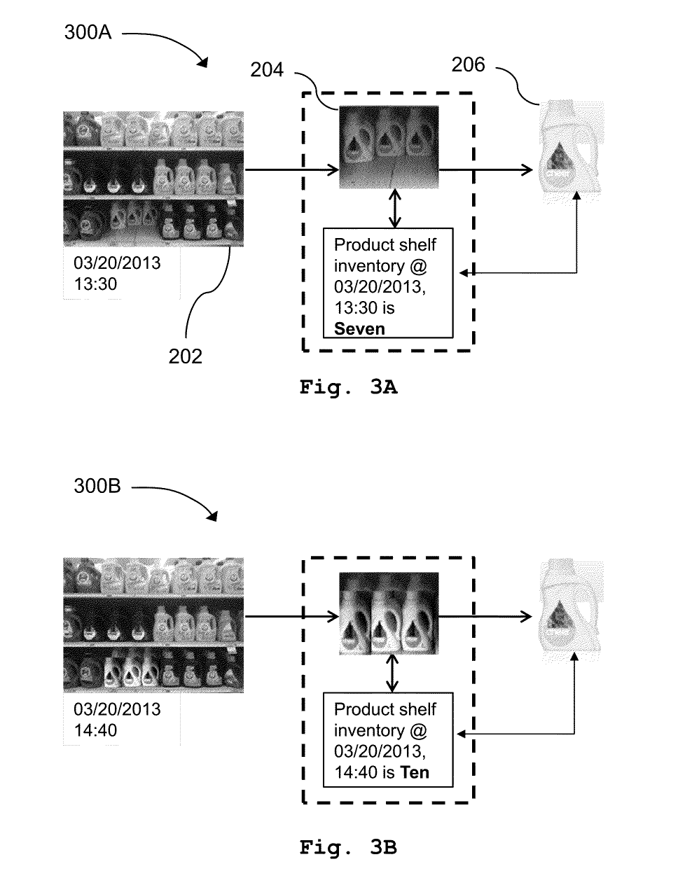

FIG. 3A is a diagram depicting an example process 300A of correlating a product inventory image with its shelf inventory data, according to one embodiment of the present invention. A shelf image 202 is captured and associated with the date and time it was captured. The shelf image 202 is segmented into an inventory image 204 and the inventory product 206 is recognized by matching image 204 with product images stored in the store's product inventory database. The current product shelf inventory count of this product is then retrieved from the inventory database. In this example, the product shelf inventory count of “Seven” is retrieved from the inventory database. The inventory image 204 and its product's inventory number “Seven” is then correlated with each other and saved into an image-count correlation database.

FIG. 3B is another diagram depicting an example process 300B of correlating a product inventory image with its shelf inventory data, according to one embodiment of the present invention. This process is identical to the process depicted in FIG. 3A except that the image and the corresponding product inventory data is captured and read at a different time instant (notice that this time the product shelf inventory count of the same detergent product becomes ten). This produces another inventory image and inventory number correlation pair which is subsequently saved into the image-count correlation database.

This image and inventory data correlation building can be an ongoing process or a one-time calibration process. Depending on the embodiment, it takes a certain period of time to build a rigorous image-count correlation database. In some embodiments, the image-count correlation database contains a large number of correlation pairs for each product type, which are collected at different time instances. The image-count correlation database is utilized in deriving the shelf inventory for a specific product type based on image matching.

Note that when the data volume becomes very large in this correlation database, certain data clustering or machine learning approaches can be applied to group images of the same product with the same inventory count. One skilled in the art will recognize the method of implementing clustering and machine learning techniques.

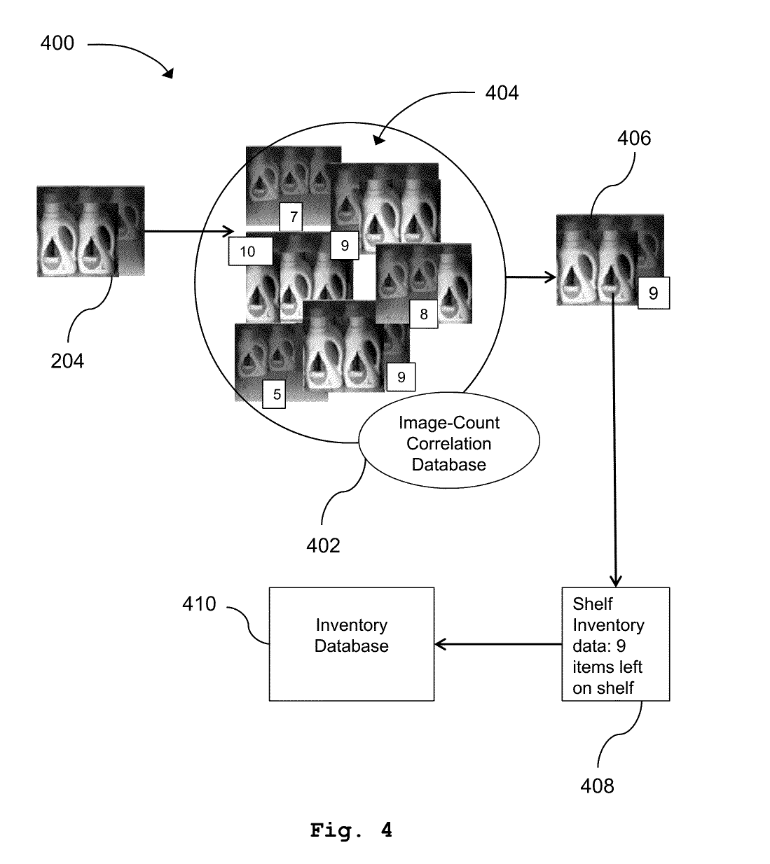

FIG. 4 is a diagram depicting an example process 400 for matching a product inventory image with images in the image-count correlation database and subsequently deriving the product's shelf inventory data, according to one embodiment of the present invention. The process 400 includes matching the first inventory image 204 with at least one historical image from a plurality of historical images 404. The historical images 404 are located in the image-count correlation database 402. The image-count correlation database 402 also includes product shelf inventory counts associated with the historical images 404 for determining the number of items on the shelf. In FIG. 4, the product shelf inventory counts are depicted as numbers appended to each associated historical image. Once a matching historical image 406 is identified, the shelf inventory data 408 of the product in the inventory image 204 is updated with the number that is associated with the matched image 406. In this example, the first inventory image 204 matches a historical image associated with an inventory count of nine. As such, the shelf inventory data 408 is updated to indicate there are nine items of the particular product type on the shelf. In this embodiment, the shelf inventory data 408 is stored in an inventory database 410 which stores the current product shelf inventory count, the product type, its barcode, and a product image for each product type on the shelf.

In one embodiment, the image-count correlation database 402 also includes a plurality of historical product images. The historical product images are matched with current segmented product images to identify products on the shelves. In one embodiment, the segmentation and product recognition processes are performed each time a shelf image 202 is captured.

In another embodiment, when the system gathers enough data to properly recognize products and segment images, the system temporarily fixes the segmented spaces of the inventory images. In this embodiment, the system will only change the segments when personnel physically reorganize the products on the shelf. As such, the system can save time and processing power.

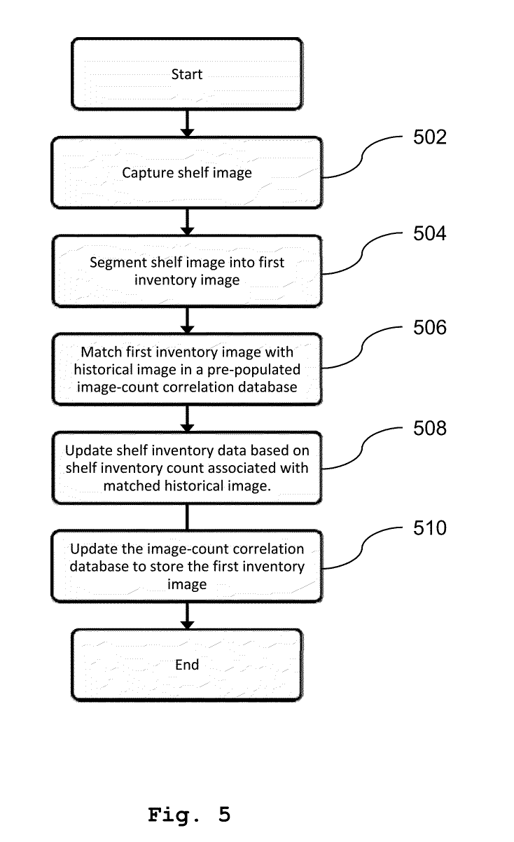

FIG. 5 is a flowchart illustrating a method for maintaining shelf inventory data on a shelf, according to one embodiment of the present invention. The method begins with capturing step 502. During capturing step 502, a first camera 108 captures a shelf image 202. After capturing step 502 is completed, the method continues to segmenting step 504.

At segmenting step 504, a computer processor segments the shelf image 202 into a first inventory image 204. The first inventory image 204 is segmented based on product type, such that the first inventory image includes items of a single product type. The computer processor may utilize different techniques to differentiate different product types, including but not limited to edge detection, color histogram data, illumination histogram data, and text detection. After segmenting step 504 is completed, the method continues to matching step 506.

At matching step 506, the processor searches the historical images 404 in a pre-populated image-count correlation database 402 for a historical image that matches the first inventory image 204. The processor identifies the matching historical image 406. In some embodiments, inventory image matching is accomplished utilizing color histogram data. After matching step 506 is completed, the method continues to updating step 508.

At updating step 508, the shelf inventory data is updated based on the inventory count associated with the matched historical image 406. After updating step 508 is completed, the method continues to updating step 510.

At updating step 510, the image-count correlation database 402 is updated to store the first inventory image 204 along with its current inventory data, as one of the historical images 404. After updating step 510 is completed, the method is complete. In one embodiment, the system is configured to set an out-of-stock flag when the product shelf inventory count is less than a predetermined number.

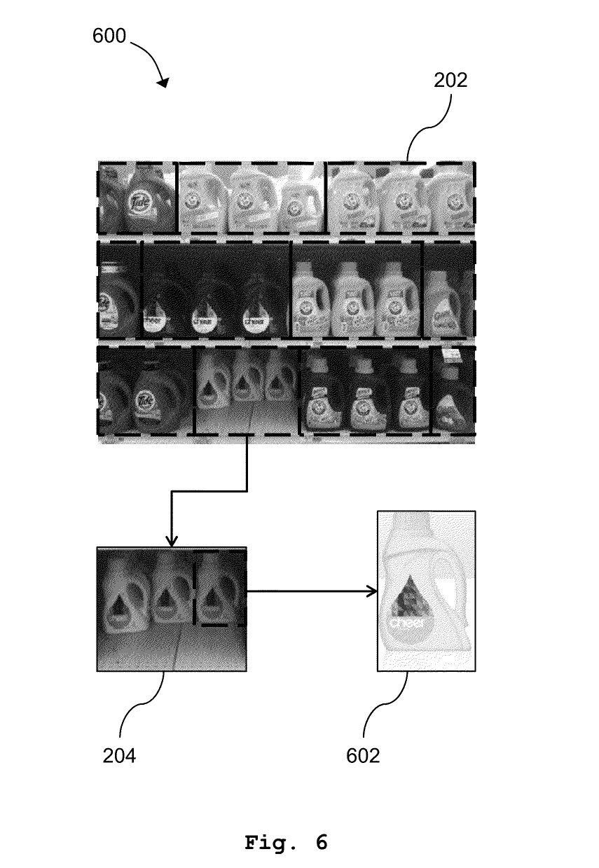

FIG. 6 is a diagram depicting an example process 600 for recognizing a particular product type from a shelf image based on image segmentation results, according to one embodiment of the present invention. The process 600 includes segmenting a shelf image 202 into a plurality of inventory images. FIG. 6 depicts a first inventory image 204, which is then matched against product images that are stored in the store's product inventory database. Subsequently, a current product image 602 contained in the first inventory image 204 is recognized.

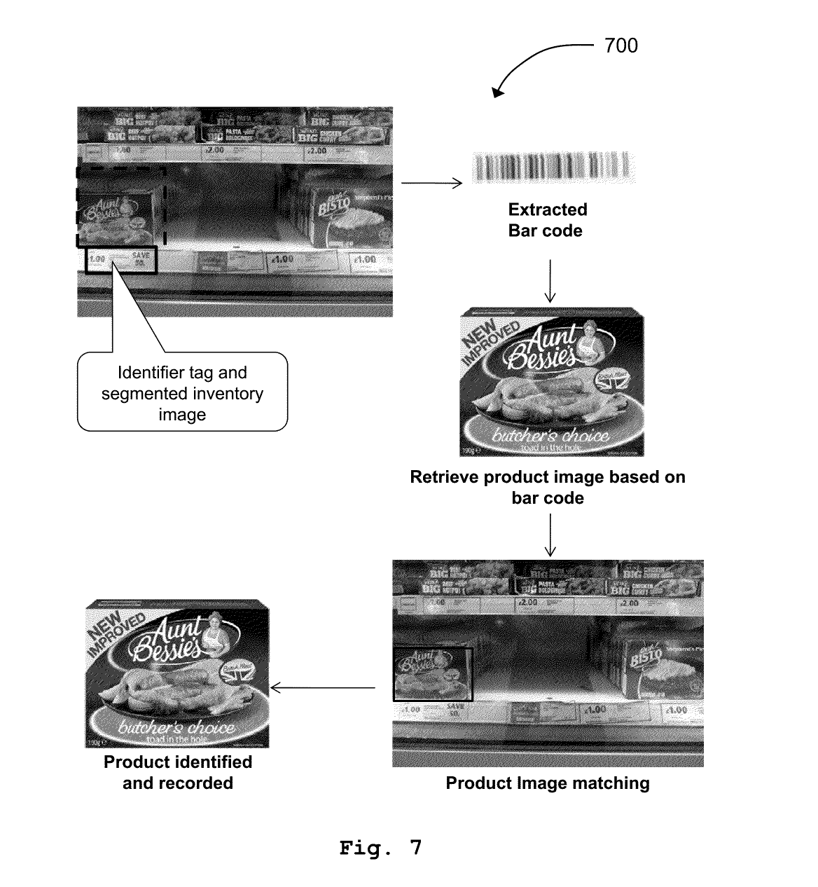

FIG. 7 is a diagram depicting an example process 700 for identifying and verifying products utilizing identifier tags, according to one embodiment of the present invention. In this embodiment, identifier tags are positioned proximate to the items on the shelves. The identifier tags include barcodes and are associated with a segmented inventory image and pre-captured product image. The barcode is extracted from the identifier tag to identify the product type of the items on the shelf. In this embodiment, the inventory database 410 includes barcode data associated with each product type. The extracted barcode is matched with the barcode data in the inventory database 410 and the associated product image is retrieved. In this example, the retrieved product image matches with the segmented product image. Thus, the product identification is confirmed.

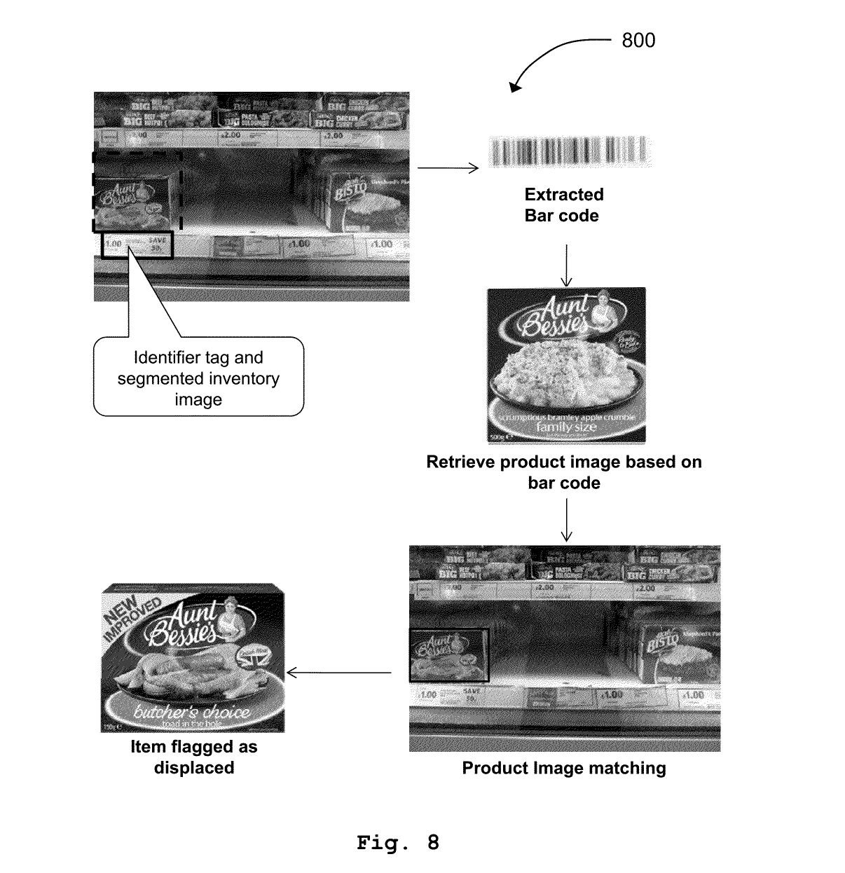

FIG. 8 is another diagram depicting an example process 800 for identifying displaced products utilizing identifier tags, according to one embodiment of the present invention. This process is identical to the process depicted in FIG. 7. However, in this example, the segmented product image does not match the product image retrieved based on the barcode. Thus, the item is flagged as displaced.

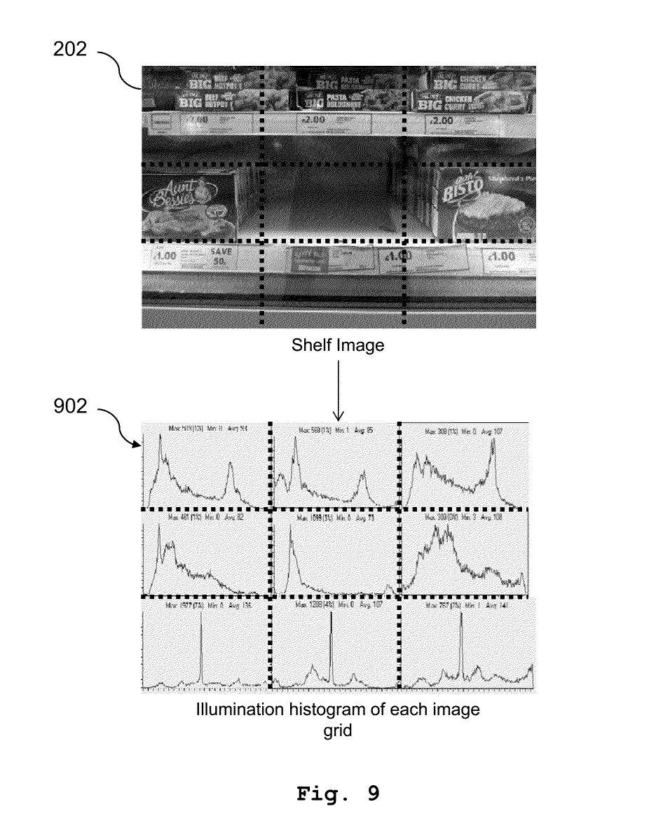

FIG. 9 is a diagram depicting an example of identifying out-of-stock products based on shelf image processing, according to one embodiment of the present invention. FIG. 9 depicts the shelf image 202 segmented into several image grids, indicated by the division lines. In this embodiment, an illumination histogram 902 is calculated for each image grid. As depicted in the figure, the illumination histogram of the center grid is different from the rest in the sense that all pixels in this grid have very low intensity. This is due to the fact that this center grid does not contain any product, in another word, the product of that center grid is out-of-stock. In some embodiments, video text detection may be utilized to identify products and/or indicate whether a product is in stock. In such embodiments, machine learning techniques may be utilized to improve the product recognition and product out-of-stock detection processes.

In one embodiment, the inventory database 410 includes a product name and its current shelf inventory data. The system is configured to update a product's shelf inventory count based on the outcome of matching the product's inventory image with the image-count correlation database.

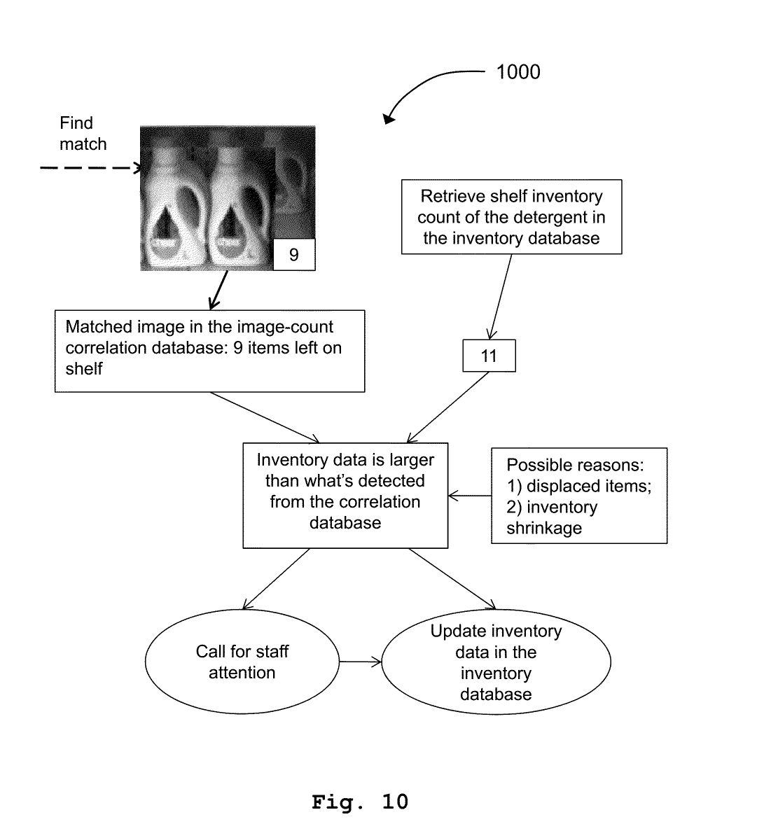

FIG. 10 is a diagram depicting an example process 1000 of maintaining and updating shelf inventory data, according to one embodiment of the present invention. In this example, the inventory image matches with a historical image in the image-count correlation database with an inventory count of 9, however, the inventory database shows that this particular product's inventory count is 11. Possible reasons for such inconsistency and for a larger count in the inventory database may be because of displaced items or inventory shrinkage. As such, the system sets a flag to notify personnel of the discrepancy. The inventory data of this product in the inventory database may be updated based on the cause of the discrepancy.

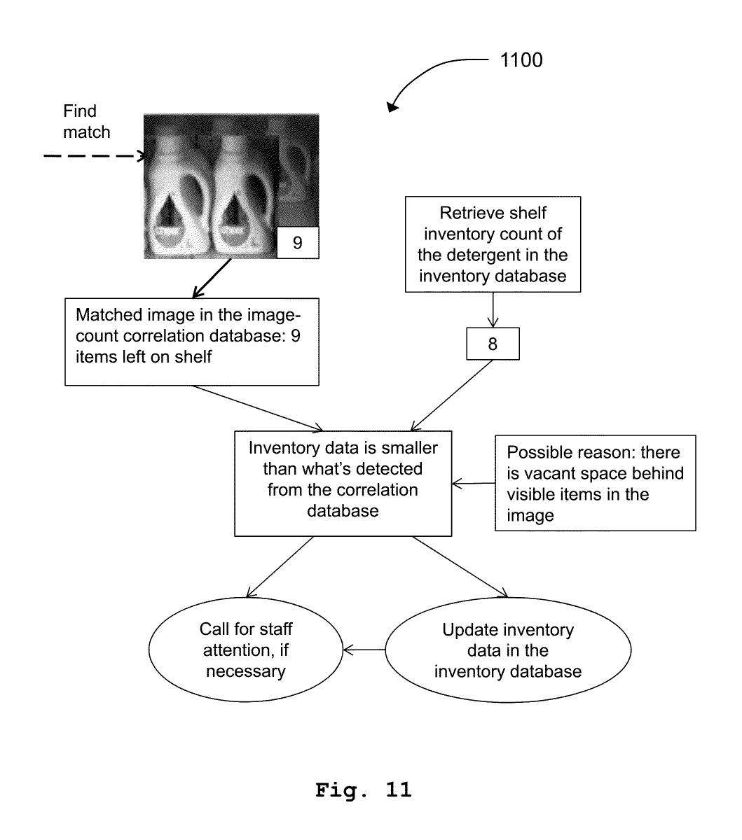

FIG. 11 is a diagram depicting an example process 1100 of maintaining and updating shelf inventory data, according to one embodiment of the present invention. In this example, the inventory image matches with a historical image in the image-count correlation database with an inventory count of 9, however, the inventory database shows that this particular product's inventory count is 8. A possible reason for such inconsistency and for a smaller count in the inventory database may be because of vacant spaces behind the items visible to the camera. As such, the system sets a flag to notify personnel of the discrepancy, and the product shelf inventory count in the inventory database may override the inventory count derived from the correlation database. Based on personnel input or the second camera capturing the same product type from a separate angle, the system may learn to recognize inventory images with vacant spaces.

In one embodiment, the image-count correlation database 402 includes a stock inventory count for each product type in a store. When the stock inventory count is less than a predetermined number, the system sets a store-out-of-stock flag.

In some embodiments, the system also includes cameras capturing, segmenting and matching inventory images of storage units other than shelves, such as store racks, storage bins, or product display units. The implementation of such embodiments would follow the same method as the embodiments based on shelf images.

In one embodiment, the automated maintenance of shelf inventory data may be utilized to measure store compliance with planograms. In such systems, measurement of planogram compliance involves three components: Distribution, Space, and Arrangement. Distribution refers to the degree that products on the shelves match the product distribution in a predetermined planogram. Space refers to the degree that space allocated for the products match the predetermined planogram. Arrangement refers to the degree that the arrangement of products match the arrangement in the predetermined planogram. For example, whether items are on the correct shelves or whether product brands are arranged in the same manner as the predetermined planogram.

In some embodiments, the automated maintenance of shelf inventory data may be utilized for generating recommendations to personnel for shelf space allocation. Such embodiments utilize product inventory data to generate recommendations. The product inventory data includes statistics on the rates of item removal and replacement of each product type.

As will be appreciated by one skilled in the art, aspects of the present invention may be embodied as a system, method or computer program product. Accordingly, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for maintaining shelf inventory data on a shelf, the system comprising:
a camera configured to capture a shelf image of a plurality of items on the shelf;
an inventory database storing data on a plurality of products, each product associated with a product type, a product image and a current product shelf inventory count;
an image-count correlation database storing a plurality of historical images for each product on the shelf and a product shelf inventory count associated with each of the historical images;
a computer processor configured to:
segment the shelf image into at least a first inventory image, the first inventory image containing only items of a single product type on the shelf;
match the first inventory image with one of the historical images in the image-count correlation database; and
update the inventory database based on the product shelf inventory count associated with the matched historical image in the image-count correlation database.

2. The system of claim 1, wherein the historical images include a plurality of inventory images of each product type, each of the inventory images are captured at different instances of time, such that each inventory image is associated with the product shelf inventory count at the time the inventory image was captured.

3. The system of claim 2, wherein the plurality of inventory images are captured and associated with the product shelf inventory count throughout a set calibration period.

4. The system of claim 2, wherein the plurality of inventory images are captured and associated with the product shelf inventory count continuously, such that the first inventory image and its associated product shelf inventory count are stored in the image-count correlation database after updating the inventory database.

5. The system of claim 1, further comprising a plurality of cameras configured to capture a plurality of shelf images, the plurality of shelf images segmented into a plurality of inventory images based on product types.

6. The system of claim 5, wherein the inventory images are segmented based on the locations of a plurality of identifier tags positioned on the shelf, such that each product on the shelf is associated with at least one identifier tag, wherein the identifier tags are recognized based on edge detection and text detection data extracted from the shelf image.

7. The system of claim 5, wherein the computer processor is further configured to segment the inventory images into a plurality of product images, each of the product images containing only one item, such that each product image is associated with one of the product types, and wherein the product images are utilized to identify the product types of items by matching a current product image with the product images in the inventory database.

8. The system of claim 7, wherein the product images are utilized to identify displaced items on the shelf by matching a current product image with a product image retrieved from the inventory database based on a barcode in an identifier tag of the product.

9. The system of claim 5, wherein the computer processor is configured to analyze the shelf images and inventory images based on at least one of edge detection data, image histogram data, text detection data, and barcode data.

10. The system of claim 1, wherein the inventory database includes product inventory data, the product inventory data including statistics on the rates of item removal and replacement of each product type.

11. A method for maintaining shelf inventory data on a shelf, the method comprising:
capturing a shelf image of a plurality of items on the shelf;
segmenting the shelf image into at least a first inventory image, the first inventory image containing only items of a single product type on the shelf;
matching the first inventory image with a historical image from an image-count correlation database, the image-count correlation database storing historical images of each product type on the shelf and a product shelf inventory count associated with each of the historical images; and
updating an inventory database based on the product shelf inventory count associated with the matched historical image in the image-count correlation database, the inventory database storing data for a plurality of products, each product associated with a product type, a product image and a current shelf inventory count.

12. The method of claim 11, wherein the inventory images are segmented based on the locations of a plurality of identifier tags positioned on the shelf, such that each product on the shelf is associated with at least one identifier tag, wherein the identifier tags are recognized based on edge detection and text detection data extracted from the shelf image.

13. The method of claim 11, further comprising:
segmenting the inventory images into a plurality of product images, each of the product images containing only one item, such that each product image is associated with the product types of the contained item; and
identifying the product types of items based on the product images by matching a current product image with product images in the inventory database.

14. The method of claim 11, further comprising populating the image-count correlation database with inventory images of each product type which are captured at different instances of time, such that each inventory image is associated with the product shelf inventory count at the time the inventory image was captured.

15. The method of claim 14, wherein the plurality of inventory images are captured and associated with the product shelf inventory count throughout a set calibration period.

16. The method of claim 14, wherein the population of the image-count correlation database is performed continuously, such that the first inventory image and its associated product shelf inventory count is stored in the image-count correlation database after updating the inventory database.

17. The method of claim 11, further comprising setting a shelf-stock flag if the product shelf inventory count is less than a set value.

18. A computer program product for maintaining shelf inventory data on a shelf, the computer program product comprising:
a computer readable storage medium having computer readable program code embodied therewith, the computer readable program code configured to:
capture a shelf image of a plurality of items on the shelf;
segment the shelf image into at least a first inventory image, the first inventory image containing only items of a single product type on the shelf;
match the first inventory image with a historical image from an image-count correlation database, the image-count correlation database storing historical images of each product type on the shelf and the product shelf inventory count associated with each of the historical images; and
update the shelf inventory data in the inventory database based on the product shelf inventory count associated with the matched historical image in the image-count correlation database.

19. The computer program product of claim 18, further comprising computer readable program code to populate the image-count correlation database with inventory images of each product type which are captured at different instances of time, such that each inventory image is associated with the product shelf inventory count at the time the inventory image was captured.

20. The computer program product of claim 18, further comprising computer readable program code to set a shelf-stock flag if the product shelf inventory count is less than a set value.
